(19) United States
(12) Patent Application Publication
(10) Pub. No.: US 2013/0047415 A1
(43) Pub. Date: Feb. 28, 2013

(54) USE OF CHAMBER HEIGHT TO AFFECT CALIBRATION CODE IN TEST STRIP MANUFACTURING

(71) Applicants: David MORRIS, Inverness (GB); Neil WHITEHEAD, Dingwall (GB)

(72) Inventors: David MORRIS, Inverness (GB); Neil WHITEHEAD, Dingwall (GB)

(73) Assignee: LifeScan Scotland Ltd., Inverness-shire (GB)

(21) Appl. No.: 13/218,924

(22) Filed: Aug. 26, 2011

(51) Int. Cl. B23P 17/04

(52) U.S. Cl. 29/592

(57) ABSTRACT

The invention provides a method for varying the intercept of a batch of test strips by varying the height of the strip's sample-receiving chamber.

### FIELD OF THE INVENTION

The invention relates to test strip manufacturing for producing electrochemical test strips. In particular, the invention relates to controlling a batch intercept by changing the sample chamber height of the strip.

### BACKGROUND OF THE INVENTION

Electrochemical test strips are designed to measure the concentrations of an analyte, such as glucose, in a body fluid sample. In the case of the measurement of glucose in a blood sample, the measurement is based on the selective oxidation of glucose, as for example, by the glucose oxidase enzyme. The glucose is oxidized to gluconic acid by the oxidized form of glucose oxidase and the oxidized enzyme is converted to the reduced state. Next, the reduced enzyme is re-oxidized by reaction with a mediator, such as ferricyanide. During this re-oxidation, the ferricyanide mediator is reduced to ferrocyanide.

When these reactions are conducted with a test voltage applied between two electrodes, a test current is created by the electrochemical re-oxidation of the reduced mediator at the electrode surface. Because, in an ideal environment, the amount of reduced mediator created during the chemical reaction is directly proportional to the amount of glucose in the sample positioned between the electrodes, the test current generated is proportional to the glucose content of the sample.

Test meters that use this principle enable an individual to sample and test a blood sample and determine the blood's glucose concentration at any given time. The glucose current generated is detected by the test meter and converted into a glucose concentration reading using an algorithm that relates the test current to a glucose concentration via a simple, mathematical formula. In general, the test meters work in conjunction with a disposable test strip that may include a sample-receiving chamber and at least two electrodes disposed within the sample-receiving chamber in addition to the enzyme and the mediator.

Such a glucose test using a test meter and strip uses batch calibration information about the test strip, such as batch slope and intercept values, determined from the manufacturing of a particular strip lot, or batch. When a user performs a glucose test using a strip from a particular strip lot, the batch slope and intercept information must be entered into the test meter used in the form of a calibration code if the information varies batch-to-batch. If the meter user forgets to enter the calibration code, there is a possibility that an inaccurate glucose measurement result will occur. Such an error can lead to insulin dose errors by the individual resulting in a hypo- or hyperglycemic episode.

To overcome this disadvantage of using test strips, strip manufacturers have developed test strips and methods of manufacturing strips, in which test strips lots can be prepared that do not require a user to input any calibration information before performing a test measurement because a high percentage of test strip lots can be produced that have a relatively constant batch slope and intercept. Thus, the test strip lots effectively have the same calibration and, when the test strips are used on a glucose test meter manufactured with the calibration information, no calibration coding is necessary or required of the user during each usage of the test strips.

### BRIEF DESCRIPTION OF THE FIGURES

FIG. 1 is an exploded, perspective view of a test strip.

FIG. 2 is a view of a cross-section of the chamber end of the test strip of FIG. 1.

FIG. 3 is a fitted line plot of the date from Table 1.

### DETAILED DESCRIPTION OF THE INVENTION

It is a discovery of the invention that the intercept of a test strip batch can be impacted by varying the height of the strip's sample-receiving chamber. More specifically, it is a discovery of the invention that the intercept of a test strip batch may be increased by decreasing the chamber height and decreased by increasing the height, thus providing an improved method for the production of single calibration code strip lots with good yields.

In one embodiment, the invention provides a method of manufacturing a test strip batch in which the chamber height is selected so that the intercept of the batch falls within a predetermined target for a predetermined calibration code. The method comprises, consists essentially of, and consists of: (a) selecting a desired first intercept for a batch of test strips; and (b) computing a chamber height to be used based on the desired first intercept and a second batch intercept obtained from a previously made test strip batch so that a resulting intercept is substantially equal to the first intercept.

The invention may find its greatest utility in electrochemical-based test strips for the determination of glucose levels in whole blood sample. For example, the present invention may find utility in the manufacture of ULTRA™-type test strips as disclosed in U.S. Pat. Nos. 5,708,247; 7,112,265; 6,241,862; 6,284,125; 7,462,265 and U.S. Patent Publication Nos. 20100112678 and 201000112612, incorporated herein in their entireties by reference.

For purposes of the invention, a “batch” of test strips is a set of strips made using one roll of substrate. A roll of substrate is a continuous piece of substrate that may or may not be spliced with one or more other rolls of substrate to form a continuous web of substrate. Typically, the roll after printing is separated into cards and again into test strips. By “intercept” is meant the intercept value for a batch.

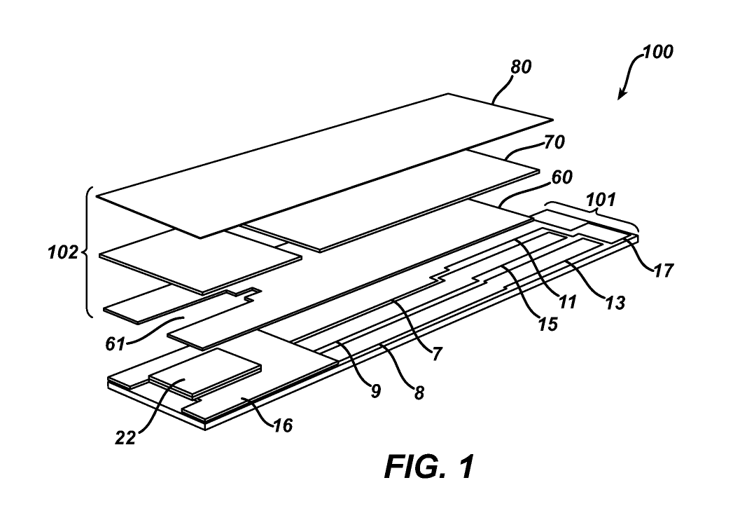

In FIG. 1 is an exploded, perspective view of an exemplary test strip 100, which may include multiple layers disposed on a substrate 3. The layers disposed on substrate 3 may be a conductive layer 101, which can also be referred to as electrode layer 101, an insulation layer 16, enzyme layer 22 and a top tape layer 102. The top tape layer 102 is composed of spacer layer 60, hydrophilic layer 70 and top tape 80.

For test strip 100, conductive layer 101 may include a reference electrode, a first working electrode, a second working electrode (all not shown), a first contact pad 13, a second contact pad 15, a reference contact pad 11, a first working electrode track 8, a second working electrode track 9, a reference electrode track 7, and a strip detection bar 17. The conductive layer may be formed from carbon ink, which may include metallic particles, a si/si chloride ink, a gold-based ink, a palladium-based ink, or any combination thereof in one or more printing steps. First contact pad 13, second contact pad 15, and reference contact pad 11 may be adapted to electrically connect to a test meter. First working electrode track 8 provides an electrically continuous pathway from the first working electrode to first contact pad 13. Second working electrode track 9 provides an electrically continuous pathway from the second working electrode to second contact pad 15. Similarly, reference electrode track 7 provides an electrically continuous pathway from the reference electrode to reference contact pad 11. A test meter can detect that test strip 100 has been properly inserted by measuring a continuity between reference contact pad 11 and strip detection bar 17.

For insulation layer 16, any suitable insulation ink may be used. One such suitable ink is ERCON™ 6110-116 jet Black Insulayer Ink available from Ercon, Inc. The enzyme ink layer 22 may be disposed on a portion of the conductive layer 101, substrate 3, and insulation layer 16 as illustrate in FIG. 1. In one embodiment, and as shown, more than one successive enzyme ink layers may be screen printed on conductive layer 101.

The enzyme ink may contain a filler having both hydrophobic and hydrophilic domains and such fillers may be disposed onto the working electrode using any suitable method including screen printing. An example of a filler may be a silica, such as CAB-O-SIL™ 610 commercially available from Cabot, Inc, Boston, Mass.

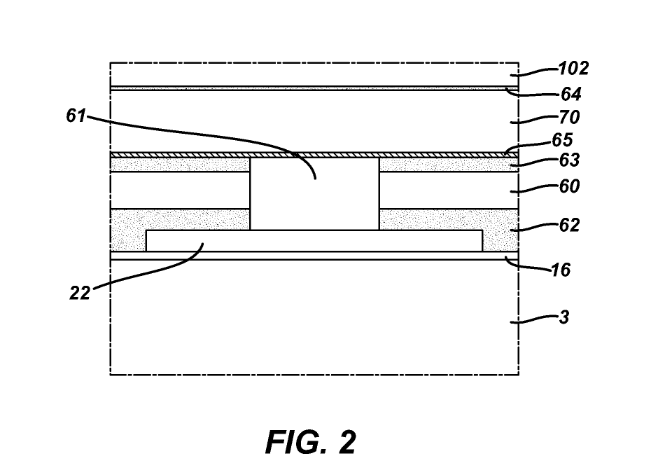

The final layer to be added to test strip 100 is top tape layer 102. As shown in the exploded view of FIG. 1 and the cross-section in FIG. 2, top tape layer 102 is composed of top tape 80, hydrophilic film layer 70, and spacer layer 60. Top tape 80 may be a polyester that has an adhesive coating layer 64 on one side, The hydrophilic layer 70 may be a polyester with one or both of its surfaces being a hydrophilic coating layer 65, such as an anti-fog coating layer. Spacer layer 60 preferably is a polyester layer with an adhesive layer on one or both of its upper and lower surfaces, such as layers 63 and 62, respectively, as shown. The adhesive layers may be formed from a water based acrylic copolymer pressure sensitive adhesive that is commercially available from Tape Specialties LTD, Tring Herts UK (part #A6435), a solvent-based adhesive, or any suitable adhesive. Preferably, top tape layer 102 is an integrated component in the form of a single laminate. An opening 61 in spacer layer 60, when overlaid onto the enzyme layers forms the sample-receiving chamber of the strip. Opening 61 may be any convenient size and shape and formed by any convenient method including laser ablation, cutting, punching or the like.

The chamber height is defined by the lower and upper adhesive spacer layers as well as the spacer thickness. If the plane of the length of the test strip is considered to be the y-axis and the plane of the width of the strip is considered to be the x-axis, then the z-axis is the plane of the height of the strip. And, the chamber height is the distance or height in the z-direction between the strip substrate and the underside of the hydrophilic layer of the top tape.

In the method of the invention, the sample-receiving chamber height is selected to achieve a desired batch intercept. It is a discovery of the invention that, by increasing or decreasing the chamber height, there will be an intercept decrease or increase, respectively. About a 1 nm change in chamber height produces about a 0.897 nA change in the intercept. Preferably, the chamber height does not exceed the range of about 90 and 200 nm for a test strip that uses blood for testing.

The chamber height may be varied by any suitable method. For example for the test strip shown in FIGS. 1 and 2, the height may be varied by changing the thickness of one or more of spacer 60, upper spacer adhesive layer 63, and lower spacer adhesive layer 62. Preferably, one or both of the adhesive layers are varied.

In the method of the invention, a desired intercept for a batch is selected. The chamber height necessary to achieve the selected intercept is then computed based on an intercept of a previously manufactured batch and the desired intercept value. After the chamber height is computed, a verification run may be performed to verify that the target intercept value will result. If the resulting value is substantially equal to the target intercept value, then the method will move forward to large-scale production batches. However, if the value is not substantially equal to the target, then the chamber height may be further adjusted and more strips prepared and tested to verify that the modified height provides the intercept value that is desired. This can be repeated as necessary.

For purposes of the invention, the intercept for a batch may be calculated as follows. An amount of strips, typically about 1500 strips, are selected at random from a batch. Blood from 12 different donors is spiked to each of six levels of glucose and eight strips are given blood from identical donors and levels so that a total of 12×6×6=576 test are conducted for that batch. These are benchmarked against actual blood glucose concentrations by measuring these using a standard laboratory analyzer such as a Yellow Springs Instrument (“YSI”). A graph of measured glucose concentration is plotted against actual glucose concentration (or a measured current versus YSI current) and a formula y=mx+c least squares fitted to the graph to give a value for batch slope m and batch intercept c for the remaining strips from the lot or batch.

It should be noted that other factors, including the amount of mediator, the conductive ink lot, the oxidized mediator lot, the mixing time and process, the standing time, the preconditioning of the substrate, the mesh type and deformability, and the working electrode area and separation and snap distance may affect one or both of the batch slope and intercept. These factors may be controlled so as to be sufficiently identical during each run so that a substantially constant slope and intercept are obtained batch-to-batch. Preferably, the working electrode area and the amount of reduced mediator are controlled as described in United States Patent Publication No. 20090208743 A1 incorporated herein in its entirety by reference, so as to achieve a substantially constant slope and intercept.

A test strip using the invention may be manufactured using any known method including using web printing, screen printing and combinations thereof. For example, the strip may be manufactured by sequential, aligned formation of a patterned conductor layer, insulation layer, reagent layer, and a top tape layer film onto an electrically insulating substrate.

An exemplary web printing process is as follows. A substrate is used that may be nylon, polycarbonate, polyimide, polyvinyl chloride, polyethylene, polypropylene, glycolated polyester, polyester and combinations thereof. Preferably, the substrate is a polyester, more preferably MELINEX™ ST328, manufactured by DuPont Teijin Films. Prior to entering one or more printing stations, the substrate may be preconditioned to reduce the amount of expansion and stretch that can occur in the strip manufacturing process. In the preconditioning step, the substrate may be heated to a temperature, which is not exceeded in the subsequent printing steps. For example, the substrate may be heated to approximately 160° C. Generally, the heating takes place under tension of between about 150 N and 180 N, more typically around 156 N. Alternatively, the substrate can be heated to a temperature sufficient to remove the irreversible stretch, again optionally while under tension as described above.

Preferably the substrate is held under tension of approximately 165 N throughout the process in order to maintain registration of the layers to be printed. The substrate is also subjected to various temperatures of about 140° C. or less in order to dry the printed inks during each printing step. Optionally, prior to printing a cleaning system may be used that cleans the top, or print, side and the underside of the substrate using a vacuum and brush system.

One or more printing steps may be used to provide an electrode layer. In one embodiment, prior to the printing process, and immediately after drying, the substrate is passed over a first, chilled roller to rapidly cool the substrate to a predetermined temperature, typically room temperature. After the printed carbon patterns are deposited in the printing process, the substrate may be passed over a second chilled roller.

For the insulation layer, an ink suitable for use as an insulation ink and applicable in a print station in a web manufacturing process is used. Immediately after drying, the substrate, including printed carbon and insulation patterns, is passed over a third, chilled roller as described above.

A first enzyme ink printing may then take place using any suitable enzyme ink. After the first enzyme ink printing process and immediately after drying, the substrate, including printed carbon and insulation patterns, is passed over a fourth, chilled roller. One or more of topside, underside and side humidification may be provided. For example, an arrangement of pipes may provide a substantially constant stream of humidified air above, below, or sideways onto the substrate and layers ensuring the water content of the ink is maintained at a constant level. The amount and arrangement of humidification, typically pipes carrying humidified air, will depend on, amongst other things, the amount of humidification required, the water content of the ink, the humidity and temperature of the surrounding air, the temperature of the substrate as it approaches the enzyme print station, the temperature of the print roller, the size of the screen and the exposure of the screen to the surrounding, un-humidified air.

The invention will be further clarified by a consideration of the following, non-limiting examples.

### EXAMPLES

Batches of test strips, configured as shown in the figures, with differing chamber heights were manufactured by the process described above and calibrated by randomly selecting 1500 strips. In Table 1 below is listed the differing chamber heights as well as the thickness variations made to achieve each of the heights.

TABLE 1

| | Lower Spacer | Spacer | Upper Spacer |
|---|---|---|---|
| | Adhesive Thickness | Thickness | Adhesive Thickness |
| Height (μm) | (μm) | (μm) | (μm) |
| 100 | 25 | 50 | 25 |
| 111 | 50 | 36 | 25 |
| 125 | 50 | 50 | 25 |
| 150 | 25 | 100 | 25 |

Blood from 12 different donors was spiked at each of 6 levels (50, 100, 150, 200, 300, and 500 mg) of glucose and 8 strips were given blood from identical donors so that a total of 12×6×8 or 576 tests were conducted for each test batch. These were benckmarked against actual blood glucose concentrations by measuring these using a standard laboratory analyzer, a Yellow Springs instrument 2300 (“YSI”). A graph of measured glucose concentration was plotted against actual glucose concentration, or measured current versus YSI current, and the formula y=mx+c least squares fitted to the graph to give a value for batch slope m and batch intercept c.

The chamber heights, slopes and intercepts are set forth in Table 2.

TABLE 2

| | | Exact Slope | |
|---|---|---|---|
| Experiment No. | Height (μm) | (μA/mg/dL) | Exact Intercept (μA) |
| 1 | 100 | 0.01990 | 0.542 |
| 1 | 111 | 0.01984 | 0.555 |
| 1 | 125 | 0.01982 | 0.522 |
| 1 | 150 | 0.01992 | 0.507 |
| 2 | 100 | 0.01964 | 0.550 |
| 2 | 111 | 0.01963 | 0.532 |
| 2 | 125 | 0.01952 | 0.522 |
| 2 | 150 | 0.01973 | 0.493 |
| 3 | 100 | 0.01910 | 0.503 |
| 3 | 111 | 0.01921 | 0.494 |
| 3 | 125 | 0.01922 | 0.470 |
| 4 | 100 | 0.01897 | 0.516 |
| 4 | 111 | 0.01883 | 0.521 |
| 4 | 125 | 0.01889 | 0.500 |
| 4 | 150 | 0.01899 | 0.488 |
| 5 | 100 | 0.02107 | 0.466 |
| 5 | 111 | 0.02117 | 0.446 |
| 5 | 125 | 0.02126 | 0.413 |
| 5 | 150 | 0.02144 | 0.416 |

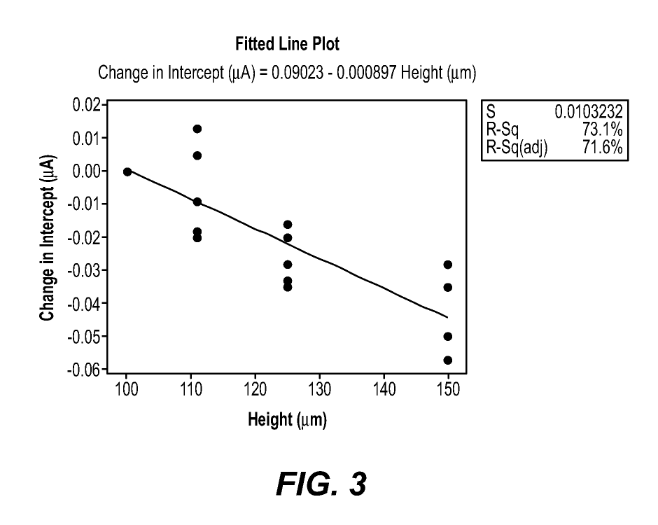

The normalized intercept data is shown in FIG. 3. The results demonstrate that there is a good correlation between chamber height and intercept (R=73.1%). The relationship, based on regression analysis, is that a 1 μm change in chamber height results in a 0.897 nA change in intercept.

What is claimed is:

1. A method of manufacturing test strips, comprising (a) selecting a desired first intercept for a batch of test strips and (b) computing a chamber height to be used based on the desired first intercept and a second batch intercept obtained from a previously made test strip batch so that a resulting intercept is substantially equal to the first intercept.
